(19) United States
(12) Patent Application Publication
(10) Pub. No.: US 2022/0394562 A1
(43) Pub. Date: Dec. 8, 2022

(54) Device and Method of Configuring a Group Handover/Cell Reselection

(71) Applicant: Google LLC, Mountain View, CA (US)

(72) Inventors: Jibing Wang, San Jose, CA (US); Erik Richard Stauffer, Sunnyvale, CA (US)

(73) Assignee: Google LLC, Mountain View, CA (US)

(21) Appl. No.: 17/775,849

(22) PCT Filed: Oct. 13, 2020
(86) PCT No.: PCT/US2020/055397

§ 371 Date: May 10, 2022

Related U.S. Application Data
(60) Provisional application No. 62/937,453, filed on Nov. 19, 2019.

(51) Int. Cl. H04W 36/00; H04W 36/32; H04W 56/00

(52) U.S. Cl. CPC H04W 36/0009; H04W 36/32; H04W 56/005

(57) ABSTRACT

This document describes methods and devices for group handover/cell reselection. A source base station (401) identifies a plurality of user equipments (110) as a group, sends a group identifier to the group, and determines to initiate a handover/cell reselection for the group. The source base station (401) then negotiates handover parameters with a target base station (402) and sends, to user equipments of the group that are in an engaged mode, a group handover command with directions to connect with the target base station (402). The source base station (401) also identifies a plurality of candidate target base stations (501) and sends, to user equipments of the group that are in a disengaged mode, a group reselection command with directions to reselect one of the plurality of candidate target base stations (501).

### BACKGROUND

The evolution of wireless communication to fifth generation (5G) standards and technologies provides higher data rates and greater capacity with improved reliability and lower latency, which enhances mobile broadband services. 5G technologies also provide new classes of service for vehicular networking, fixed wireless broadband, and the Internet of Things (IoT).

Use of 5G technologies, however, presents certain challenges, such as those involving handover or cell reselection techniques. Conventional handover and cell reselection techniques, for example, do not efficiently process handovers or cell reselections of groups of user equipments that concurrently require a handover or cell reselection, such as groups of user equipments in a train or in a car traveling together that are leaving a coverage area of a serving base station.

### SUMMARY

This summary is provided to introduce simplified concepts for configuring a group handover/cell reselection. The simplified concepts are further described in the Detailed Description below. This summary is not intended to identify essential features of the claimed subject matter nor is it intended for use in determining the scope of the claimed subject matter.

Methods, devices, systems, and means for configuring a group handover or cell reselection are described. A source base station first associates a group of user equipments with a group identifier, e.g., based on location and movement information, and transmits the group identifier to the group of user equipments. The source base station then determines to initiate the group handover/cell reselection of the group of user equipments from the source base station to one or more target base stations. The source base station, for user equipments of the group that are in an engaged mode: negotiates handover parameters for the user equipments that are in the engaged mode with a target base station and sends the handover parameters, including the group identifier, to the group as a group handover command. The source base station also, for user equipments of the group that are in a disengaged mode: identifies one or more target base stations for use in cell reselection by the user equipments that are in the disengaged mode and sends contextual information about the user equipments to the target base stations. The source base station then sends, to the user equipments that are in the disengaged mode, a group cell reselection command that includes the group identifier and directs the user equipments to reselect one of the target base stations.

### BRIEF DESCRIPTION OF THE DRAWINGS

Aspects for configuring a group handover/cell reselection are described with reference to the following drawings. The same numbers are used throughout the drawings to reference like features and components:

FIG. 1 illustrates an example wireless network environment in which various aspects for configuring a group handover/cell reselection can be implemented.

FIG. 2 illustrates an example device diagram for devices that can implement various aspects for configuring a group handover/cell reselection in the example wireless network environment of FIG. 1.

FIG. 3 illustrates example user equipment states of the user equipments of FIGS. 1 and 2.

FIG. 4 illustrates an example signaling diagram for configuring a group handover for user equipments of a group that are in an engaged mode.

FIG. 5 illustrates an example signaling diagram for configuring a group cell reselection for user equipments of a group that are in a disengaged mode.

FIG. 6 illustrates an example method for configuring a group handover/cell reselection from a perspective of a source base station.

FIG. 7 illustrates an example method for implementing a group handover from a perspective of a user equipment that is in an engaged state.

FIG. 8 illustrates an example method for implementing a group cell reselection from a perspective of a user equipment that is in a disengaged state.

### DETAILED DESCRIPTION

Overview

This document describes methods, devices, systems, and means for a group handover/cell reselection of multiple user equipment (UE) from a source base station (e.g., a Fifth Generation (5G) New Radio (NR) base station or another radio access technology (RAT) base station) to one or more target base stations (e.g., other 5G NR base stations or other RAT base stations). The source base station, which is in communication with the UEs, determines that the UEs may be considered as a group, and thus, can be handed over or reselected together to a target base station. The source base station assigns a unique group identifier to the group and transmits the group identifier to the group of UEs such that each of the UE can determine when future group handover commands or group cell reselection commands are applicable to the UEs of the group. The group of UEs may include any number of UE that are in an engaged mode, disengaged mode, or both engaged and disengaged modes. Responsive to determining, by the source base station, to hand over the group of UEs to the one or more target base stations (with or without input from the UE(s)), the source base station sends out a group handover command to UEs of the group that are in the engaged mode and/or a group cell reselection command to UEs of the group that are in the disengaged mode. The group handover and cell reselection commands include the group identifier and handover/cell reselection parameters, respectively, and instruct the UEs to initiate a handover/reselect to one of the target base stations. By doing so, the source base station enables the handover/cell reselection of the UEs to the target base stations as a group instead of performing individualized handover/cell reselection procedures for the respective UEs individually. This leads to reduced handover and cell reselection latency for the UEs as well as reduced collective signaling overhead when the UEs may be handed over/reselected as a group.

Consider, for example, a situation where a plurality of UEs are in communication with a source base station and are traveling together, e.g., on a train or subway. Assume that the communication quality with the source base station is degrading or insufficient, such as if the UEs are moving away from the source base station, e.g., approaching a cell edge.

In such a case, a handover/cell reselection of the UEs from the source base station to a target base station is desired, e.g. based on measurement reports associated with communications between the UEs and the source or target base stations. As noted above, however, conventional techniques for handovers/cell reselections are insufficient for handing over or reselecting a group of UEs from a source base station to target base station(s). In order to perform the handover/cell reselection of the group, conventional techniques necessitate individual handovers/cell reselections for each of the UEs, depending on respective modes of the UEs. Because of this, techniques for establishing group handovers/group cell reselections for groups of user equipments can reduce latency of handovers/cell reselections and reduce overall signaling overhead compared to conventional individual handover/cell reselection.

While features and concepts of the described systems and methods for group handover/cell reselection can be implemented in any number of different environments, systems, and/or devices, aspects of these handover/cell reselection techniques are described in the context of the following example devices and systems.

Example Environment

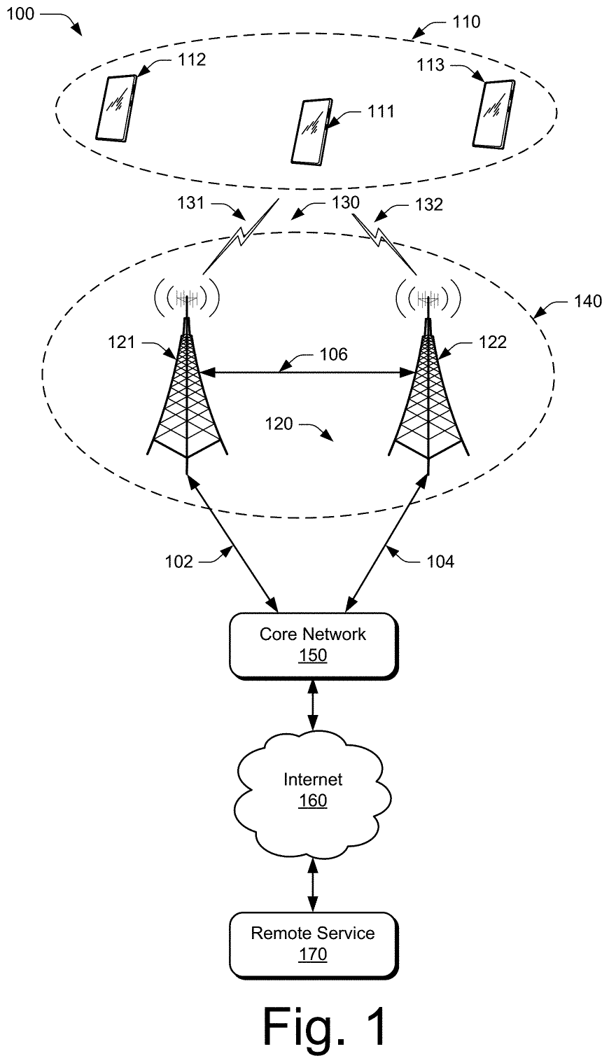

FIG. 1 illustrates an example environment 100 which includes user equipments 110 (UE 110), illustrated as user equipments 111, 112, and 113, that can communicate with base stations 120, illustrated as base stations 121 and 122, through one or more wireless communication links 130 (wireless link 130), illustrated as wireless links 131 and 132. For simplicity, the UE 110 are illustrated as smartphones but each of the UE 110 may be implemented as any suitable computing or electronic device, such as a mobile communication device, modem, cellular phone, gaming device, navigation device, media device, laptop computer, desktop computer, tablet computer, smart appliance, vehicle-based communication system, or an Internet-of-Things (IoT) device such as a sensor or an actuator. The base stations 120 (e.g., an Evolved Universal Terrestrial Radio Access Network Node B, E-UTRAN Node B, evolved Node B, eNodeB, eNB, Next Generation Node B, gNode B, gNB, ng-eNB, or the like) may be implemented in a macrocell, microcell, small cell, picocell, and the like, or any combination thereof.

The base stations 120 communicate with the user equipment 110 using the wireless links 131 and 132, which may be implemented as any suitable type of wireless link. The wireless links 131 and 132 include control and data communication, such as downlink of data and control information communicated from the base stations 120 to the UE 110, uplink of other data and control information communicated from the user equipment 110 to the base stations 120, or both. The wireless links 130 may include one or more wireless links (e.g., radio links) or bearers implemented using any suitable communication protocol or standard, or combination of communication protocols or standards, such as 3rd Generation Partnership Project Long-Term Evolution (3GPP LTE), Fifth Generation New Radio (5G NR), and so forth. Multiple wireless links 130 may be aggregated in a carrier aggregation to provide a higher data rate for the UE 110. Multiple wireless links 130 from multiple base stations 120 may be configured for Coordinated Multipoint (CoMP) communication with the UE 110.

The base stations 120 are collectively a Radio Access Network 140 (e.g., RAN, Evolved Universal Terrestrial Radio Access Network, E-UTRAN, 5G NR RAN or NR RAN). The base stations 121 and 122 in the RAN 140 are connected to a core network 150. The base stations 121 and 122 connect, at 102 and 104 respectively, to the core network 150 through an NG2 interface for control-plane signaling and using an NG3 interface for user-plane data communications when connecting to a 5G core network, or using an Si interface for control-plane signaling and user-plane data communications when connecting to an Evolved Packet Core (EPC) network. The base stations 121 and 122 can communicate using an Xn Application Protocol (XnAP) through an Xn interface, or using an X2 Application Protocol (X2AP) through an X2 interface, at 106, to exchange user-plane and control-plane data. The user equipment 110 may connect, via the core network 150, to public networks, such as the Internet 160 to interact with a remote service 170.

Example Devices

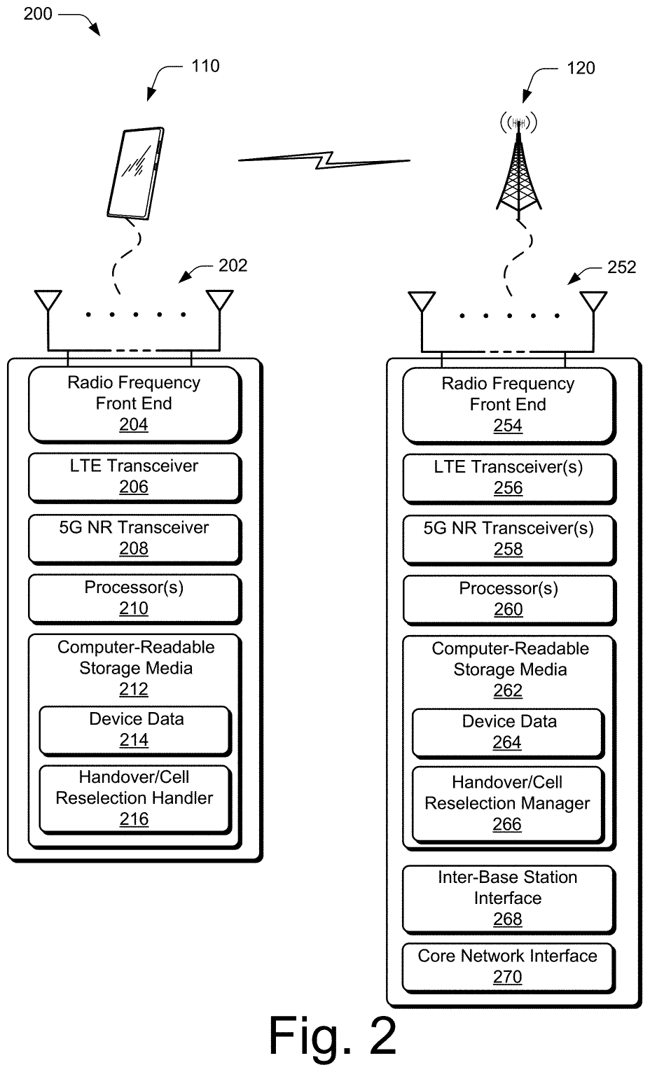

FIG. 2 illustrates an example device diagram 200 of the UE 110 and the base stations 120. The UE 110 and the base stations 120 may include additional functions and interfaces that are omitted from FIG. 2 for the sake of clarity. The UE 110 includes antennas 202, a radio frequency front end 204 (RF front end 204), an LTE transceiver 206, and a 5G NR transceiver 208 for communicating with base stations 120 in the 5G RAN 141 and/or the E-UTRAN 142. The RF front end 204 of the UE 110 can couple or connect the LTE transceiver 206, and the 5G NR transceiver 208 to the antennas 202 to facilitate various types of wireless communication. The antennas 202 of the UE 110 may include an array of multiple antennas that are configured similar to or differently from each other. The antennas 202 and the RF front end 204 can be tuned to, and/or be tunable to, one or more frequency bands defined by the 3GPP LTE and 5G NR communication standards and implemented by the LTE transceiver 206, and/or the 5G NR transceiver 208. Additionally, the antennas 202, the RF front end 204, the LTE transceiver 206, and/or the 5G NR transceiver 208 may be configured to support beamforming for the transmission and reception of communications with the base stations 120. By way of example and not limitation, the antennas 202 and the RF front end 204 can be implemented for operation in sub-gigahertz bands, sub-6 GHZ bands, and/or above 6 GHz bands that are defined by the 3GPP LTE and 5G NR communication standards.

The UE 110 also includes processor(s) 210 and computer-readable storage media 212 (CRM 212). The processor 210 may be a single core processor or a multiple core processor composed of a variety of materials, such as silicon, polysilicon, high-K dielectric, copper, and so on. The computer-readable storage media described herein excludes propagating signals. CRM 212 may include any suitable memory or storage device such as random-access memory (RAM), static RAM (SRAM), dynamic RAM (DRAM), non-volatile RAM (NVRAM), read-only memory (ROM), or Flash memory useable to store device data 214 of the UE 110. The device data 214 includes user data, multimedia data, beamforming codebooks, applications, and/or an operating system of the UE 110, which are executable by processor(s) 210 to enable user-plane communication, control-plane signaling, and user interaction with the UE 110.

CRM 212 also includes instructions for implementing a handover/cell reselection handler 216. Alternately or additionally, the handover/cell reselection handler 216 may be implemented in whole or part as hardware logic or circuitry integrated with or separate from other components of the UE 110. In at least some aspects, the handover/cell reselection handler 216 configures the RF front end 204, the LTE transceiver 206, and/or the 5G NR transceiver 208 to implement the techniques for implementing a group handover/cell reselection described herein.

The device diagram for the base stations 120, shown in FIG. 2, includes a single network node or multiple network nodes (e.g., eNB, a gNode B or next generation eNB). The functionality of the base stations 120 may be distributed across multiple network nodes or devices and may be distributed in any fashion suitable to perform the functions described herein. The base stations 120 include antennas 252, a radio frequency front end 254 (RF front end 254), one or more LTE transceivers 256, and/or one or more 5G NR transceivers 258 for communicating with the UE 110. The RF front end 254 of the base stations 120 can couple or connect the LTE transceivers 256 and the 5G NR transceivers 258 to the antennas 252 to facilitate various types of wireless communication. The antennas 252 of the base stations 120 may include an array of multiple antennas that are configured similar to or differently from each other. The antennas 252 and the RF front end 254 can be tuned to, and/or be tunable to, one or more frequency band defined by the 3GPP LTE and 5G NR communication standards, and implemented by the LTE transceivers 256, and/or the 5G NR transceivers 258. Additionally, the antennas 252, the RF front end 254, the LTE transceivers 256, and/or the 5G NR transceivers 258 may be configured to support beamforming, such as Massive-MIMO, for the transmission and reception of communications with the UE 110.

The base stations 120 also include processor(s) 260 and computer-readable storage media 262 (CRM 262). The processor 260 may be a single core processor or a multiple core processor composed of a variety of materials, such as silicon, polysilicon, high-K dielectric, copper, and so on. CRM 262 may include any suitable memory or storage device such as random-access memory (RAM), static RAM (SRAM), dynamic RAM (DRAM), non-volatile RAM (NVRAM), read-only memory (ROM), or Flash memory useable to store device data 264 of the base stations 120. The device data 264 includes network scheduling data, radio resource management data, beamforming codebooks, applications, and/or an operating system of the base stations 120, which are executable by processor(s) 260 to enable communication with the UE 110.

CRM 262 also includes instructions for implementing a handover manager 266. Alternately or additionally, the handover manager 266 may be implemented in whole or part as hardware logic or circuitry integrated with or separate from other components of the base stations 120. In at least some aspects, the handover manager 266 performs, in whole or in part when acting as a source base station, the techniques described herein. The handover/cell reselection manager 266 configures the LTE transceivers 256 and the 5G NR transceivers 258 for communication with the UE 110, as well as communication with a core network. The base stations 120 include an inter-base station interface 268, such as an Xn and/or X2 interface, which the handover/cell reselection manager 266 configures to exchange user-plane and control-plane data between another base station 120 (including handovers/cell reselections between them), to manage the communication of the base stations 120 with the UE 110. The base stations 120 include a core network interface 270 that the handover/cell reselection manager 266 configures to exchange user-plane and control-plane data with core network functions and entities.

User Equipment States

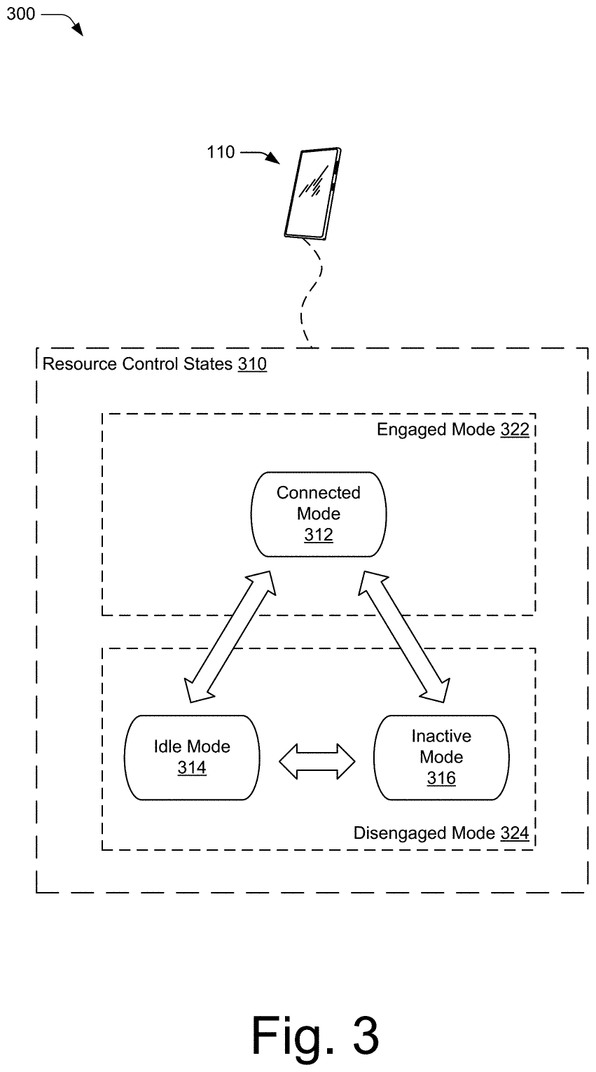

FIG. 3 illustrates example user equipment states 300 which may benefit from aspects of group handover/cell reselection participation. A wireless network operator provides its telecommunication services to user equipment devices through a wireless network. To communicate wirelessly with the network, a user equipment 110 utilizes a radio resource control (RRC) procedure to establish a connection to the network via a cell (e.g., a base station, a serving cell). Upon establishing the connection to the network via the base station 121, the UE 110 enters a connected mode (e.g., RRC connected mode, RRC_CONNECTED state, NR-RRC CONNECTED state, E-UTRA RRC CONNECTED state).

The UE 110 operates according to different resource control states 310. Different situations may occur that cause the UE 110 to transition between the different resource control states 310 as determined by the radio access technology. Examples of the resource control states 310 illustrated in FIG. 3 include a connected mode 312, an idle mode 314, and an inactive mode 316. A user equipment 110 is either in the connected mode 312 or in the inactive mode 316 when an RRC connection is active. If an RRC connection is not active, then the user equipment 110 is in the idle mode 314.

In establishing an RRC connection, the user equipment 110 may transition from the idle mode 314 to the connected mode 312. After establishing the connection, the user equipment 110 may transition (e.g., upon connection inactivation) from the connected mode 312 to an inactive mode 316 (e.g., RRC inactive mode, RRC_INACTIVE state, NR-RRC INACTIVE state) and the user equipment 110 may transition (e.g., via an RRC connection resume procedure) from the inactive mode 316 to the connected mode 312. After establishing the connection, the user equipment 110 may transition between the connected mode 312 to an idle mode 314 (e.g., RRC idle mode, RRC_IDLE state, NR-RRC IDLE state, E-UTRA RRC IDLE state), for instance upon the network releasing the RRC connection. Further, the user equipment 110 may transition between the inactive mode 316 and the idle mode 314.

Further, the UE 110 may be in an engaged mode 322 or may be in a disengaged mode 324. As used herein, an engaged mode 322 is a connected mode (e.g., the connected mode 312) and a disengaged mode 324 is an idle, disconnected, connected-but-inactive, or connected-but-dormant mode (e.g., idle mode 314, inactive mode 316). In some cases, in the disengaged mode 324, the UE 110 may still be Network Access Stratum (NAS) registered with radio bearer active (e.g., inactive mode 316).

Each of the different resource control states 310 may have different quantities or types of resources available, which may affect power consumption within the UE 110. In general, the connected mode 312 represents the UE 110 actively connected to (engaged with) the base station 121. In the inactive mode 316, the UE 110 suspends connectivity with the base station 121 and retains information that enables connectivity with the base station 121 to be quickly re-established. In the idle mode 314 the UE 110 releases the connection with the base station 121.

As a group of UE, UE 110 may have user equipments in any of the above resource control states or modes, including all the UE 110 being in the engaged mode or all of the UE 110 being in the disengaged mode.

Some of the resource control states 310 may be limited to certain radio access technologies. For example, the inactive mode 316 may be supported in LTE Release 15 (eLTE), 5G NR, and 6G, but not in 3G or previous generations of 4G standards. Other resource control states may be common or compatible across multiple radio access technologies, such as the connected mode 312 or the idle mode 314.

Signaling and Control Transactions

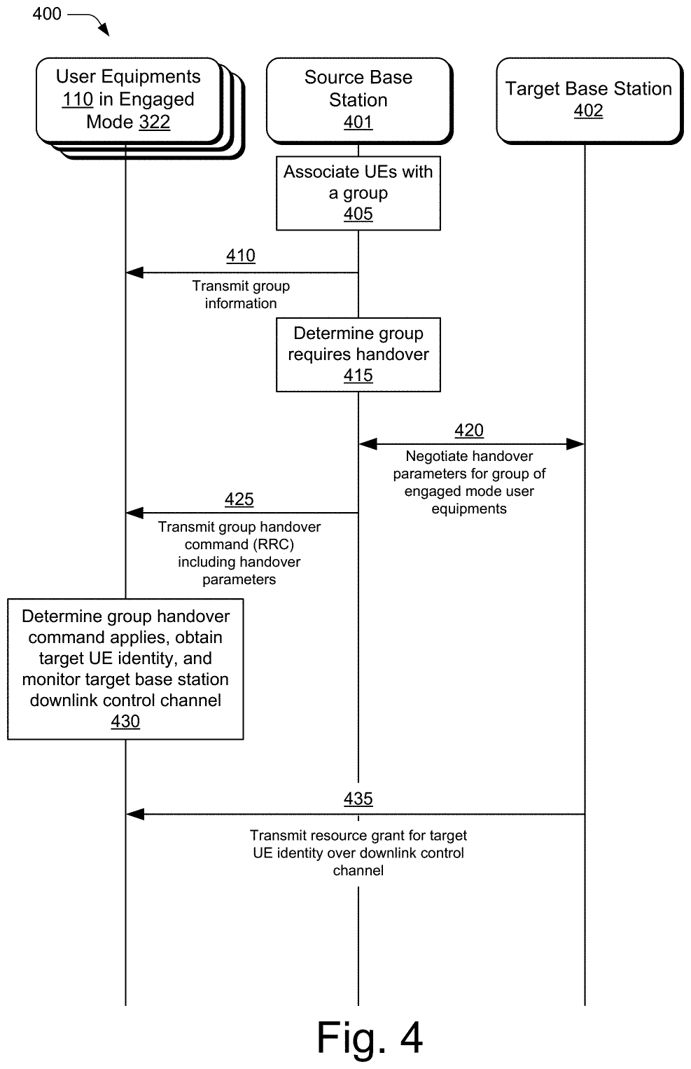

FIG. 4 illustrates details 400 of example signaling and control transactions associated with a group handover of user equipments 110 that are in the engaged mode 322 (e.g., RRC_CONNECTED) in accordance with aspects of techniques described herein. For simplicity, the user equipments that are in the engaged mode 322 will be referred to simply as engaged mode UEs. The signaling and control transactions may occur in accordance with data frames or subframes of wireless communication protocols such as 5G NR wireless communication protocols. Furthermore, this example signaling and control diagram may occur amongst the engaged mode UEs, user equipments 110 that are in the disengaged mode 324, a source base station 401 (e.g., last serving base station, base station 121), and a target base station 402 (e.g., base station 122).

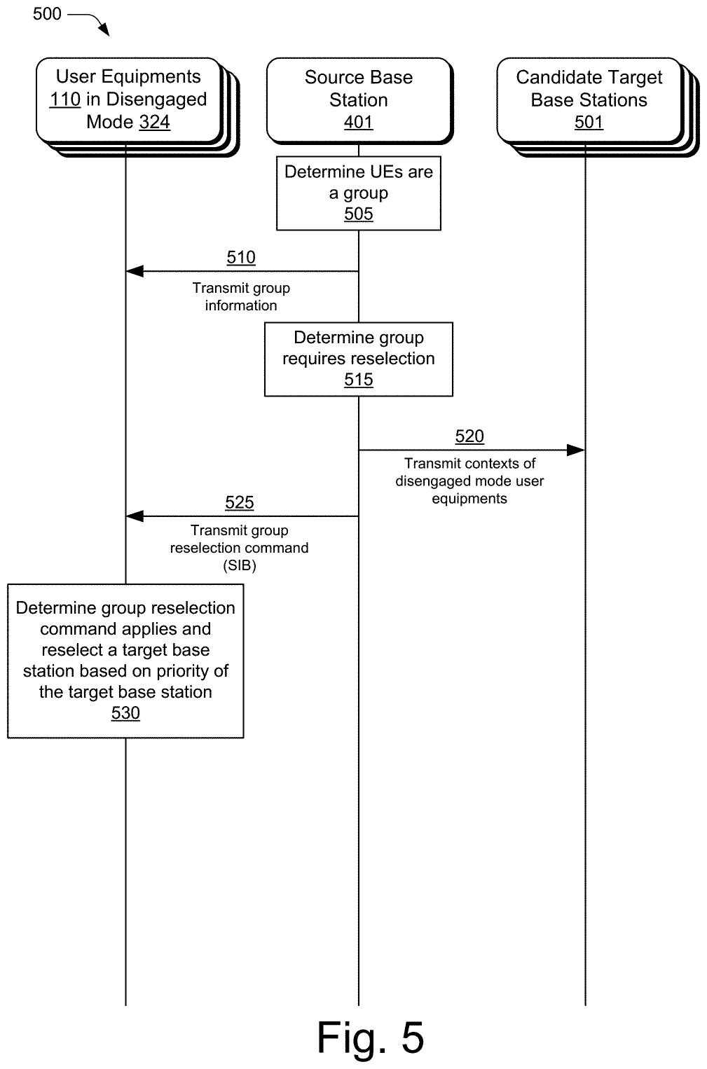

At 405, the source base station 401 determines that the engaged mode UEs are part of a group for the purposes of a handover. The group may also include UEs that are in the disengaged mode 324 (“disengaged mode UEs”), which have different signaling (see discussion for FIG. 5). The grouping may be based on location and movement data for the UEs of the group being similar (either determined by the source base station 401 or received from the UEs of the group directly). Regardless of how the grouping of the UEs is determined, at 410, the source base station 401 transmits a group identifier for receipt by the engaged mode UEs. The group identifier may also be transmitted to the disengaged mode UEs, which will also be discussed in relation to FIG. 5. The group identifier is usable by each of the engaged mode UEs to determine when future group handover messages from the source base station 401 are applicable to the engaged mode UEs of the group and not to UEs of another group.

At 415, the source base station 401 determines to initiate a handover of the set of engaged mode UEs. The source base station 401 may concurrently determine to initiate a cell reselection of a non-overlapping set of disengaged mode UEs. The determination may be based on the location data of the engaged mode UEs (e.g., engaged mode UEs will be leaving a geographic area covered by source base station 401) or may be based on measurement reports for signals transmitted between one or more of the UEs of the group and the source base station or target base stations.

At 420, the source base station 401 negotiates one or more group handover parameters for the engaged mode UEs with the target base station 402 using source UE identities of the engaged mode UEs. The group handover parameters are usable by the engaged mode UEs to connect to the target base station 402. For example, the group handover parameters may include negotiated information about the target base station (e.g., ID, location, RAT), a negotiated time for which the engaged mode UEs should monitor a downlink control channel of the target base station 402 for resource grants, or timing advances for the engaged mode UEs for communicating with the target base station 402. The source base station may determine the timing advances based on the location and movement information of the engaged mode UEs and a location of target base station 402. For example, sub-groups of the engaged mode UEs may each have an applicable timing advance. In some implementations, the handover parameters may include target UE identities, e.g., Cell Radio Network Temporary Identifiers (C-RNTIs), for the engaged mode UEs for connecting with the target base station 402 and information for mapping source UE identities to the target UE identities.

At 425, the source base station 401 transmits a group handover command to the engaged mode UEs. The group handover command includes the group identifier and the group handover parameters, and the group handover command directs each UEs of the set of engaged mode UEs to initiate a handover to the target base station 402. The group handover command may be a radio resource control (RRC) message and may be extended to a multi-RAT dual connectivity (MR-DC) environment. For example, the source base station may be associated with a secondary cell group (SCG) or the source base station may be associated with a master cell group (MCG) and the group handover parameters dictate that the engaged mode UEs should perform the handover within the SCG. In some implementations, the source base station transmits the group handover message as a broadcast or multicast message and may be sent with a lowest common modulation coding scheme (MCS) decodable by all the engaged mode UEs in the set. Furthermore, the group handover message may be repeatably transmitted to the engaged mode UEs (not illustrated in FIG. 4).

At 430, each of the engaged mode UEs in the set determine that the group handover command applies (e.g., based on the received group identifier at 410), obtains the target UE identities based on the group handover parameters, and monitors a downlink control channel of the target base station 402 for resource grants. The target UE identities may be mapped by the engaged mode UEs based on the source UE identities and the handover parameters. In some implementations, the target UE identities are the same as the source UE identities.

At 435, the engaged mode UEs receive, from the target base station 402, resource grants over the downlink control channel of the target base station 402. The resource grants (uplink and/or downlink) enable the engaged mode UEs to continue communication over wireless network 140 through target base station 402.

FIG. 5 illustrates details 500 of example signaling and control transactions associated with a group cell reselection of user equipments that are in the disengaged mode 324 (e.g., RRC_INACTIVE, RRC_IDLE) in accordance with aspects of techniques described herein. For simplicity, as noted above in the description of FIG. 4, the group of user equipments that are in the disengaged mode 324 will be referred to simply as disengaged mode UEs. The signaling and control transactions may occur in accordance with data frames or subframes of wireless communication protocols such as 5G NR wireless communication protocols. Furthermore, this example signaling and control diagram may occur amongst the disengaged mode UEs, the source base station 401, and one or more candidate target base stations 501.

At 505, the source base station 401 determines that the disengaged mode UEs are part of a group for the purposes of a cell reselection. As stated above, the group may also include the engaged mode UEs of FIG. 4, and the grouping may be performed as a single grouping of both disengaged mode UEs and engaged mode UEs. For example, the grouping may be based on a location determination of the disengaged mode UEs by the source base station 401. Regardless of how the grouping of the UEs is determined, at 510, the source base station 401 transmits a group identifier for receipt by the disengaged mode UEs. The group identifier may be the same as that sent to the engaged mode UEs. The group identifier is usable by each of the disengaged mode UEs to determine when future group cell reselection messages from the source base station 401 are applicable.

At 515, the source base station 401 determines to initiate cell reselection for the set of disengaged mode UEs. Depending on the composition of the group, this may occur in conjunction with the determination to handover the engaged mode UEs of the group. The determination may be based on the location data of one or more of the disengaged mode UEs (e.g., disengaged mode UEs will be leaving a geographic area covered by source base station 401) or may be based on one or more measurement reports for signals transmitted between one or more of the UEs of the group and the source base station 401 or candidate target base stations 501.

Steps 505 through 515 are similar to those of steps 405 through 415. Although shown on different signaling diagrams, as mentioned above, some of the steps may be performed in parallel. For example, associating UEs with the group (steps 405 and 505) may be done for both engaged mode UEs and disengaged mode UEs concurrently. As such, the group identifier may be usable by the UEs of the group to identify with the group regardless of the mode of the respective UEs. Similarly, source base station 401 may determine, as a single action, that the group requires a handover for the engaged mode UEs and requires a cell reselection for the disengaged mode UEs. Although the specific communications of the group identifiers and source UE identities may be different (based on different RRC modes), as a whole, the above steps of FIG. 5 are similar to the first three steps of FIG. 4. The differences in the processes for the two states of the UE 110 (engaged and disengaged modes) become apparent when considering the differences between steps 420 through 435 and steps 520 through 530, because handover and cell reselection processes differ.

At 520, the source base station 401 determines candidate target base stations 501 for cell reselection and prioritizes the candidate target base stations 501 for listing in the group cell reselection parameters to send to the set of disengaged mode UEs. As part of the compilation, the source base station 401 sends contextual information about the disengaged mode UEs, such as UE identities (source UE identities), bit rates, mobility restrictions, security capabilities, signaling references, or protocol data unit session resources to the candidate target base stations 501. The priorities of the candidate target base stations 501 may be based on locations of the candidate target base stations 501 and/or based on information received from the candidate target base stations 501 responsive to sending the contextual information, e.g., availability to accept the potential cell reselections. By sending the contextual information about the disengaged mode UEs to the candidate target base stations 501, radio area network (RAN) notification area updates are not required after the disengaged mode UEs connect to one of the candidate target base stations 501.

At 525, the source base station 401 transmits a group cell reselection command to the set of disengaged mode UEs. The group cell reselection command includes the group identifier and group cell reselection parameters, and the group cell reselection command instructs each of the set of disengaged mode UEs to initiate a cell reselection to one of candidate target base stations 501. The group cell reselection parameters are usable by the disengaged mode UEs to acquire or camp on the candidate target base stations 501. For example, the group cell reselection parameters may include information about the candidate target base stations 501 (e.g., IDs, locations, RATs, frequencies, physical cell IDs (PCIs)) and the priority levels of the candidate target base stations 501. The group cell reselection command may be transmitted in a system information block (SIB) message and may be transmitted on all paging cycles to reach the disengaged mode UEs. A paging indication may command disengaged mode UEs to read the group cell reselection command. In some implementations, the source base station sends the group cell reselection message as a broadcast or multicast message. The source base station 401 may send the group reselection message using a lowest common modulation coding scheme (MCS) decodable by all the disengaged mode UEs in the set.

At 530, each of the disengaged mode UEs in the set determine that the group cell reselection command applies (e.g., based on the group identifier) and initiates a cell reselection procedure. The cell reselection procedure includes attempting to acquire or camp on one of the candidate target base stations 501 based on a priority of the target base station and information about the target base station from the group cell reselection parameters. If a disengaged mode UE cannot camp on a target base station with a highest priority, the disengaged mode UE attempts to camp on another target base station with a next highest priority. The priority applies to both inter-frequency and intra-frequency cell reselection. In some instances, all of the disengaged mode UEs reselect to a single target base station (which may be the same or different than target base station 402), while in other instances, a portion of the set of disengaged mode UEs reselect to a first target base station while another portion of the disengaged mode UEs reselect to a second target base station.

The techniques, systems, and signaling described above enable group handovers and group reselections of UEs between a source base station and one or more target base stations such that individual UE handovers and reselections need not occur. The techniques and signaling are described further in reference to the example methods described below.

Example Methods

Example methods 600-800 are described with reference to FIGS. 4 and 5 in accordance with one or more aspects for configuring a group handover/cell reselection. The order in which the method blocks are described are not intended to be construed as a limitation, and any number of the described method blocks can be combined in any order to implement a method or an alternate method. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

Configuring a Handover

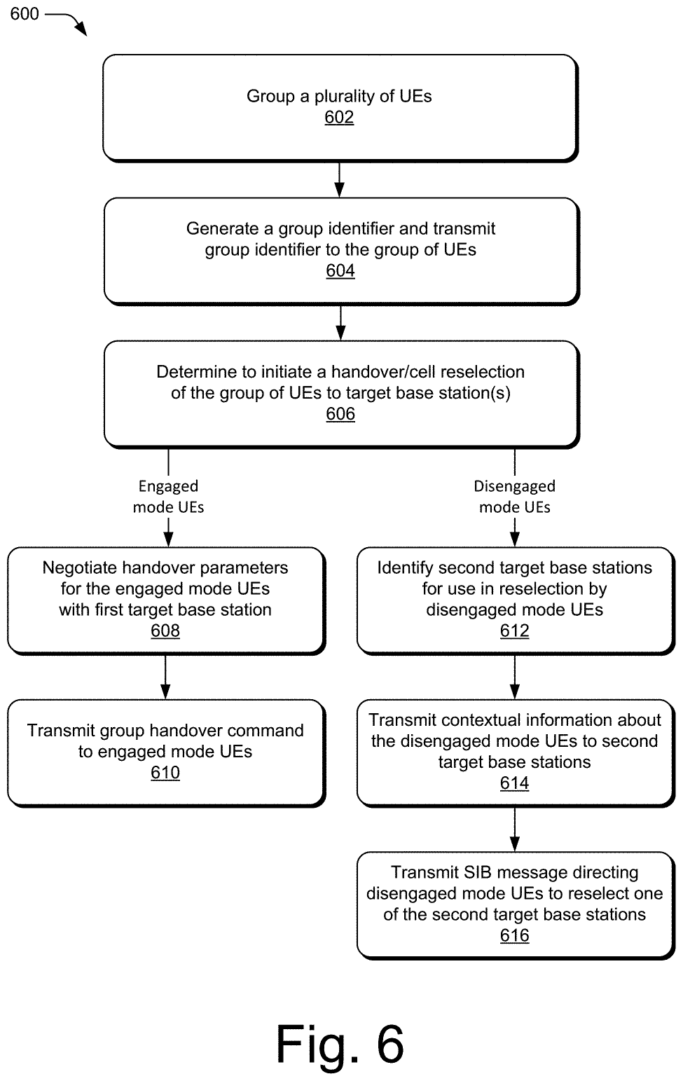

FIG. 6 illustrates example method 600 for configuring a group handover/cell reselection by the source base station in accordance with aspects of the techniques described herein.

At block 602, the source base station (e.g., a last-serving base station, base station 121, source base station 401) groups a plurality of user equipments (UEs, e.g., UE 110). The grouping may be based on location and movement data for the UEs being similar (either determined by the source base station or received from one or more of the UEs directly). The group may include UEs that are in the engaged mode 322 and UEs that are in the disengaged mode 324, referred to as engaged mode UEs and disengaged mode UEs, respectively, in the following description.

Responsive to grouping the UEs, at block 604, the source base station generates at least one group identifier and transmits the group identifier to the UEs within the group such that the UEs can determine when future handover/cell reselection commands apply. If a UE of the group transitions from engaged mode to disengaged mode or visa-versa, the UE may simply look for handover/cell reselection commands with the group identifier based on the updated mode.

At block 606, the source base station determines that a transfer of the group of UEs between the source base station and one or more target base stations is required or otherwise warranted. The transfer involves a group handover for the engaged mode UEs within the group and cell reselection for the disengaged mode UEs of the group. The determination may be based on the location data of one or more of the UEs (e.g., group will be leaving a geographic area covered by the source base station) or may be based on one or more measurement reports for communications between one or more of the UEs and the source or target base stations.

Blocks 608 and 610, and blocks 612 through 616 may be performed concurrently or sequentially. Furthermore, depending on the composition of the group of UEs (e.g., all in engaged mode or all in disengaged mode) at the time of determining to initiate a handover or cell reselection per block 606, the source base station may only perform blocks 608 and 610 (without blocks 612 through 616) or only blocks 612 through 616 (without blocks 608 and 610).

For engaged mode UEs of the group, at block 608, the source base station determines and/or negotiates group handover parameters for the engaged mode UEs with a first target base station (e.g., target base station 402). The group handover parameters are usable by the engaged mode UEs to connect to the first target base station. For example, the group handover parameters may include negotiated information about the first target base station (e.g., ID, location, RAT), a negotiated time for which the engaged mode UEs should monitor a downlink control channel of the first target base station for resource grants, one or more timing advances calculated by the source base station for the engaged mode UEs for communicating with the first target base station, or negotiated information for UE identities for use in communicating with the first target base station (may be the same or different than those used to communicate with the source base station). The timing advances may be determined by the source base station based on the engaged mode UEs location and movement information and a location of the first target base station. For example, sub-groups of engaged mode UE may each have an applicable timing advance.

At block 610, the source base station transmits a group handover command to the engaged mode UEs. The group handover command includes the group identifier and the group handover parameters, and the group handover command instructs the engaged mode UEs to initiate a handover to the first target base station. The group handover command may be a radio resource control (RRC) message and may be extended to a multi-RAT dual connectivity (MR-DC) environment. For example, the source base station may be associated with a secondary cell group (SCG) or the source base station may be associated with a master cell group (MCG) and the group handover parameters dictate that the UE 110 should perform the handover in accordance with the SCG.

For disengaged mode UEs of the group, at block 612, the source base station compiles a list of one or more second target base stations (e.g., candidate target base stations 501) and prioritizes the second target base stations for listing in the group cell reselection parameters to send to the disengaged mode UEs. As part of the compilation, the source base station sends contextual information about the disengaged mode UEs at block 614, such as UE identities, bit rates, mobility restrictions, security capabilities, or signaling references to the second target base stations. By sending the contextual information about the disengaged mode UEs to the second target base stations, radio area network (RAN) notification area updates are not required after the disengaged mode UEs connect to the second target base stations.

At block 616, the source base station transmits a group cell reselection command to the disengaged mode UEs. The group cell reselection command includes the group identifier and group cell reselection parameters, and the group cell reselection command instructs the disengaged mode UEs to initiate a cell reselection to one of the second target base stations. The group cell reselection parameters are usable by the disengaged mode UE to connect to one of the second target base stations. For example, the group cell reselection parameters may include information about the second target base stations (e.g., IDs, locations, RATs, frequencies, physical cell IDs (PCIs)) and the priority levels of the second target base stations. The group cell reselection command may be a system information block (SIB) message and, in some implementations, may be transmitted on all paging cycles to increase the likelihood that the disengaged mode UEs receive the group cell reselection command. A paging indication may command the disengaged mode UEs to read the group cell reselection command.

Although described above in terms of a single group identifier for UEs of the group regardless of user modes, in some embodiments, the source base station may assign a plurality of group identifiers each applicable to respective modes of the UEs of the group. For example, a first group identifier (or a first short or data field of a main group identifier) may be used for the engaged mode UEs of the group and a second group identifier (or a first short or data field of a main group identifier) may be used for the disengaged mode UEs of the group. Respective group identifiers (or fields of a main group identifier) may also be used for idle, inactive, and connected modes of the group.

The plurality of group identifiers may be sent to the UEs such that the UEs can recognize or otherwise “obey” the respective commands based on their user modes. For example, if a UE of the group is in the engaged mode, then the UE would act upon commands associated with the engaged mode identifier (e.g., group handover command with the engaged mode identifier) and ignore commands associated with the disengaged mode identifier (e.g., group reselection command with the disengaged mode identifier). If the UE transitions from engaged mode to disengaged mode or visa-versa, the UE may simply act upon the command with the identifier for the current user mode.

Performing a Group Handover

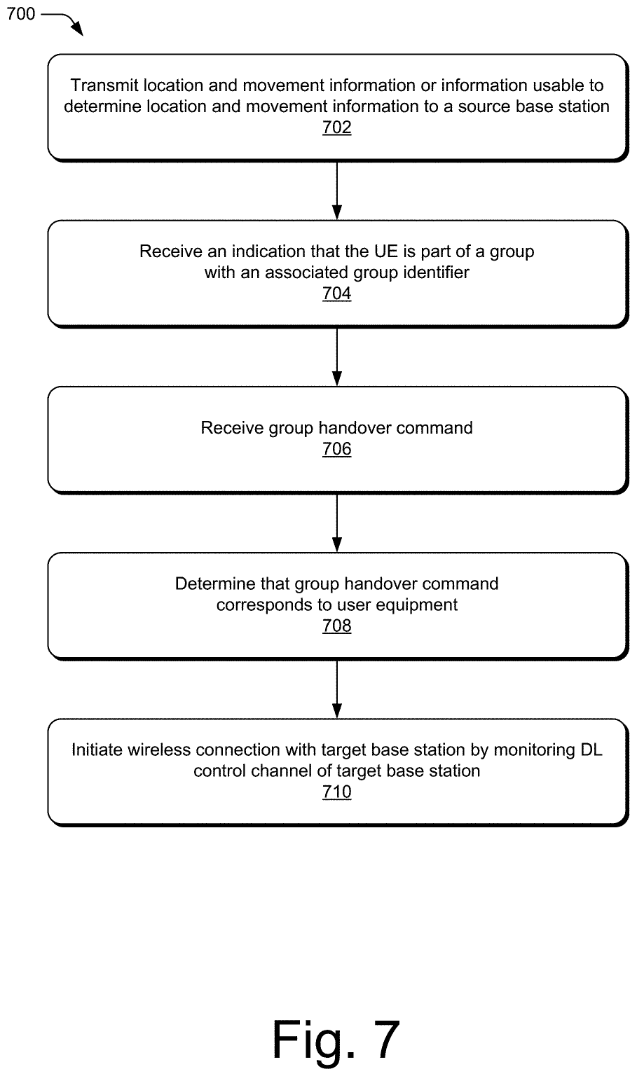

FIG. 7 illustrates example method 700 for performing a group handover by a user device (e.g., one of UE 110) that is in an engaged mode (engaged mode UE) between a source base station (e.g., source base station 401) and a target base station (e.g., target base station 402) in accordance with aspects of the techniques described herein.

At block 702, the engaged mode UE transmits location and movement information of the engaged mode UE or information usable to determine location and movement information to the source base station. The location and movement information may be based on GPS information, terrestrial triangulation between base stations, other devices near the engaged mode UE, or other sensor data from the engaged mode UE. The location and movement information may comprise a location, a heading or direction of movement, a speed, or an elevation of the engaged mode UE.

At block 704, the engaged mode UE receives, from the source base station, an indication that the engaged mode UE is part of a group with an associated group identifier.

At block 706, the engaged mode UE receives, from the source base station, a group handover command. The group handover command includes the group identifier and group handover parameters, and the group handover command instructs the engaged mode UE to initiate a handover to the target base station. For example, the group handover parameters may include information about the target base station (e.g., ID, location, RAT), a time for which the engaged mode UE should monitor a downlink control channel of the target base station for resource grants, a timing advance for the engaged mode UE for communicating with the target base station, or information for a target UE identity for use in communicating with the first target base station (may be the same or different than that used to communicate with the source base station). In some implementations, the group handover parameters dictate that the engaged mode UE should perform the handover in accordance with an SCG.

At block 708, the engaged mode UE determines that the group handover command applies (e.g., based on the group identifier).

At block 710, the engaged mode UE initiates a wireless connection with the target base station by determining the target UE identity based on the group handover parameters (may be mapped by the engaged mode UE based on a source UE identity or may be the same identity as the source UE identity) and monitors the downlink control channel of the target base station for resource grants. The engaged mode UE then receives a downlink and/or an uplink grant from the target base station and begins communicating with the target base station using the resources identified in the resource grant(s).

Performing a Group Cell Reselection

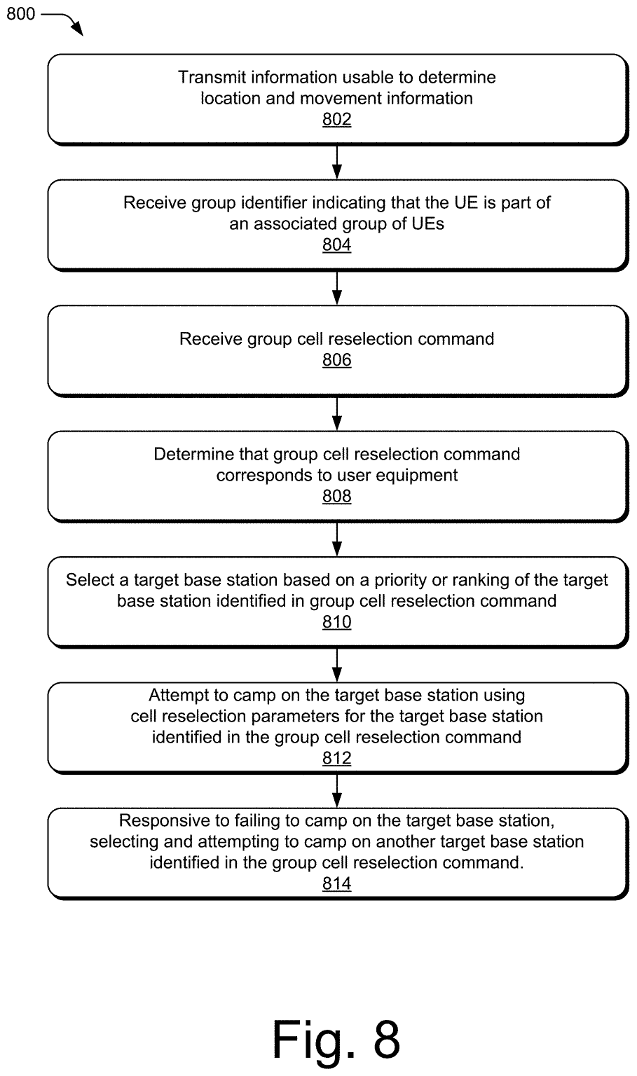

FIG. 8 illustrates example method(s) 800 for performing a cell reselection by a user device (e.g., one of UE 110) that is in a disengaged mode (disengaged mode UE) between a source base station (e.g., source base station 401) and one or more target base stations (e.g., candidate target base stations 501) in accordance with aspects of the techniques described herein.

At block 802, the disengaged mode UE send information usable by the source base station to determine location and movement information of the disengaged mode UE.

At block 804, the disengaged mode UE receives, from the source base station, an indication that the disengaged mode UE is part of a group with an associated group identifier.

At block 806, the disengaged mode UE receives, from the source base station, a group cell reselection command. The group cell reselection command includes the group identifier and group cell reselection parameters, and the group cell reselection command instructs the disengaged mode UE to initiate a cell reselection to one of the target base stations that are identified in the group cell reselection command. The group cell reselection parameters are usable by the disengaged mode UE to connect to the target base stations. For example, the group cell reselection parameters may include information about the target base stations (e.g., IDs, locations, RATs, frequencies, physical cell IDs (PCIs)) and the priority levels of the target base stations. The group cell reselection command may be embedded within a system information block (SIB) message. In some implementations, the disengaged mode UE may receive a paging indication from the source base station that commands the disengaged mode UE 110 to read the group cell reselection command.

At block 808, the disengaged mode UE determines that the group cell reselection command applies to it (e.g., based on the group identifier) and initiates a cell reselection procedure based on the cell reselection command.

At block 810, the disengaged mode UE selects one of the target base stations from the cell reselection command based on a priority of the target base station, and, at block 812, the disengaged mode UE attempts to camp on the selected target base station using the cell reselection parameters for the selected target base station.

At block 812, if the disengaged mode UE cannot camp on the selected target base station, the disengaged mode UE attempts to camp on another target base station with a next highest priority. The priority applies to both inter-frequency and intra-frequency cell reselection.

Although aspects for configuring a group handover/cell reselection have been described in language specific to features and/or methods, the subject of the appended claims is not necessarily limited to the specific features or methods described. Rather, the specific features and methods are disclosed as example implementations of the group handover/cell reselection, and other equivalent features and methods are intended to be within the scope of the appended claims. Further, various aspects are described, and it is to be appreciated that each described aspect can be implemented independently or in connection with one or more other described aspects.

### EXAMPLES

In the following, several examples are described.

Example 1: A method for performing a transfer of a group of user equipment by a source base station, the method comprising: associating, by the source base station, the group of user equipment with at least one group identifier; transmitting the group identifier to the group of user equipment; determining, by the source base station, to initiate the transfer of the group of user equipment from the source base station to one or more target base stations; for user equipments of the group of user equipment that are in an engaged mode: negotiating, by the source base station and with a first target base station, handover parameters for the user equipments of the group of user equipment that are in the engaged mode, the handover parameters usable by the user equipments of the group of user equipment that are in the engaged mode to receive resource grants from the first target base station; and transmitting, by the source base station and to the user equipments of the group of user equipment that are in the engaged mode, a group handover command comprising the group identifier and the handover parameters for the first target base station, the group handover command directing the user equipments to connect with the first target base station using the handover parameters; and for user equipments of the group of user equipment that are in a disengaged mode: identifying, by the source base station, one or more second target base stations for use in cell reselection by the user equipments of the group of user equipment that are in the disengaged mode; transmitting, by the source base station and to the one or more second target base stations, contextual information about the user equipments of the group of user equipment that are in the disengaged mode; and transmitting, by the source base station and to the user equipments of the group of user equipment that are in the disengaged mode, a group reselection command comprising the group identifier, the group reselection command directing the user equipments of the group of user equipment that are in the disengaged mode to reselect one of the second target base stations.

Example 2: The method as recited in example 1, further comprising: determining, by the source base station, at least one timing advance for the user equipments of the group of user equipment that are in the engaged mode for the first target base station, wherein the handover parameters comprise the timing advance.

Example 3: The method as recited in example 2, further comprising: determining location and movement information for the user equipments of the group of user equipment that are in the engaged mode and a location of the first target base station; and calculating the timing advance based on the location and movement information.

Example 4: The method as recited in example 3, wherein: the at least one timing advance comprises a plurality of timing advances; and each of the plurality of timing advances is applicable to a sub-group of the user equipments of the group of user equipment that are in the engaged mode.

Example 5: The method as recited in example 4, further comprising: mapping, by the source base station, the timing advances to the respective sub-groups of the user equipments of the group of user equipment that are in the engaged mode based on the location and movement information.

Example 6: The method as recited in any of the preceding examples, wherein the transmitting the group handover command comprises: transmitting the group handover command with the lowest common modulation coding scheme decodable by the user equipments of the group of user equipment that are in the engaged mode.

Example 7: The method as recited in any of the preceding examples, wherein the negotiating the handover parameters comprises: transmitting, by the source base station and to the first target base station, identities for each user equipment of the group of user equipments that are in the engaged mode that are associated with the group identifier.

Example 8: The method as recited in any of the preceding examples: wherein the one or more second target base stations comprise a plurality of second target base stations; and further comprising: ranking, by the source base station, the plurality of second target base stations, wherein the group reselection command further: includes the ranking of the second target base stations; and directs the user equipments of the group of user equipment that are in the disengaged mode to reselect to one of the second target base stations based on the ranking of the second target base stations.

Example 9: The method as recited in any of the preceding examples, further comprising: receiving or calculating, by the source base station, location and movement information for each user equipment of the group of user equipment; and forming, by the source base station, the group of user equipment based on the received or calculated location and movement information for each of the user equipment of the group of user equipment being similar to another user equipment of the group of user equipment, wherein the determining to initiate the transfer of the group of user equipment is based on the location and movement information for each user equipment of the group and a location of the first target base station.

Example 10: A method for performing a transfer of a user equipment from a source base station to one of a plurality of target base stations, the method comprising: receiving, by the user equipment and from the source base station, at least one group identifier indicating that the user equipment is part of an associated group of user equipments; receiving, by the user equipment and from the source base station: a group handover command comprising a received group identifier, comprising handover parameters for a first target base station of the plurality of target base stations, the handover parameters usable by the user equipment to monitor a control channel of the first target base station for a resource grant for the user equipment, and directing the user equipment to connect to the first target base station; or a group reselection command comprising the received group identifier, comprising reselection parameters usable by the user equipment to reselect to any of one or more second target base stations of the plurality of target base stations, comprising priorities or rankings of each of the second target base stations, and directing the user equipment to reselect one of the second target base stations; determining, based on the at least one group identifier matching the received group identifier in the group handover command or group reselection command, that the group handover command corresponds to the user equipment; and if the group handover command is received, initiating a wireless connection with the first target base station using the handover parameters for the first target base station, or if the group reselection command is received, selecting one of the second target base stations based on the priority or ranking of the selected second target base station; and attempting to camp on the selected second target base station.

Example 11: The method as recited in example 10, further comprising: transmitting, by the user equipment and to the source base station, location and movement information of the user equipment or information usable by the source base station to calculate the location and movement information of the user equipment.

Example 12: The method as recited in example 10 or 11, further comprising, if the group reselection command is received: failing to camp on the selected second target base station; identifying another second target base station from the second target base stations based on the priority or ranking of the other second target base station; and attempting to camp on the other second target base station.

Example 13: The method as recited in example 10, 11, or 12, wherein receiving the handover parameters comprises: receiving a timing advance for use by the user equipment in communicating with the first target base station.

Example 14: A base station apparatus comprising: a wireless transceiver; a processor; and computer-readable storage media comprising instructions to implement a handover/cell reselection manager that responsive to execution by the processor, directs the base station apparatus to perform any one of examples 1 to 9.

Example 15: A user equipment apparatus comprising: a wireless transceiver; a processor; and computer-readable storage media comprising instructions to implement a handover/cell reselection handler that, responsive to execution by the processor, directs the user equipment apparatus to perform any one of methods 10 to 13.

Example 16: The method as recited in any of examples 1 to 9 or 11 to 13, wherein the group identifier comprises a plurality of group identifiers, a first of the group identifiers being associated with the engaged mode of the user equipments of the group of user equipment and a second of the group identifiers being associated with the disengaged mode of the user equipments of the group of user equipment.

1. A method for performing a transfer of a group of user equipment by a source base station, the method comprising:
associating, by the source base station, the group of user equipment with at least one group identifier;
transmitting the group identifier to the group of user equipment;
determining, by the source base station, to initiate the transfer of the group of user equipment from the source base station to one or more target base stations;
for user equipments of the group of user equipment that are in an engaged mode:
negotiating, by the source base station and with a first target base station, handover parameters for the user equipments of the group of user equipment that are in the engaged mode, the handover parameters usable by the user equipments of the group of user equipment that are in the engaged mode to receive resource grants from the first target base station; and
transmitting, by the source base station and to the user equipments of the group of user equipment that are in the engaged mode, a group handover command comprising the group identifier and the handover parameters for the first target base station, the group handover command directing the user equipments to connect with the first target base station using the handover parameters; and
for user equipments of the group of user equipment that are in a disengaged mode:
identifying, by the source base station, one or more second target base stations for use in cell reselection by the user equipments of the group of user equipment that are in the disengaged mode;
transmitting, by the source base station and to the one or more second target base stations, contextual information about the user equipments of the group of user equipment that are in the disengaged mode; and
transmitting, by the source base station and to the user equipments of the group of user equipment that are in the disengaged mode, a group reselection command comprising the group identifier, the group reselection command directing the user equipments of the group of user equipment that are in the disengaged mode to reselect one of the second target base stations.

2. The method as recited in claim 1, further comprising:
determining, by the source base station, at least one timing advance for the user equipments of the group of user equipment that are in the engaged mode for the first target base station,
wherein the handover parameters comprise the timing advance.

3. The method as recited in claim 2, further comprising:
determining location and movement information for the user equipments of the group of user equipment that are in the engaged mode and a location of the first target base station; and
calculating the timing advance based on the location and movement information.

4. The method as recited in claim 3, wherein:
the at least one timing advance comprises a plurality of timing advances; and
each of the plurality of timing advances is applicable to a sub-group of the user equipments of the group of user equipment that are in the engaged mode.

5. The method as recited in claim 4, further comprising:
mapping, by the source base station, the timing advances to the respective sub-groups of the user equipments of the group of user equipment that are in the engaged mode based on the location and movement information.

6. The method as recited in claim 1, wherein the transmitting the group handover command comprises:
transmitting the group handover command with the lowest common modulation coding scheme decodable by the user equipments of the group of user equipment that are in the engaged mode.

7. The method as recited in claim 1, wherein the negotiating the handover parameters comprises:
transmitting, by the source base station and to the first target base station, identities for each user equipment of the group of user equipments that are in the engaged mode that are associated with the group identifier.

8. The method as recited in claim 1:
wherein the one or more second target base stations comprise a plurality of second target base stations; and
further comprising:
ranking, by the source base station, the plurality of second target base stations,
wherein the group reselection command further:
includes the ranking of the second target base stations; and
directs the user equipments of the group of user equipment that are in the disengaged mode to reselect to one of the second target base stations based on the ranking of the second target base stations.

9. The method as recited in claim 1, further comprising:
receiving or calculating, by the source base station, location and movement information for each user equipment of the group of user equipment; and
forming, by the source base station, the group of user equipment based on the received or calculated location and movement information for each of the user equipment of the group of user equipment being similar to another user equipment of the group of user equipment,
wherein the determining to initiate the transfer of the group of user equipment is based on the location and movement information for each user equipment of the group and a location of the first target base station.

10. A method for performing a transfer of a user equipment from a source base station to one of a plurality of target base stations, the method comprising:
receiving, by the user equipment and from the source base station, at least one group identifier indicating that the user equipment is part of an associated group of user equipments;
receiving, by the user equipment and from the source base station at least one of:
a group handover command
comprising a received group identifier,
comprising handover parameters for a first target base station of the plurality of target base stations, the handover parameters usable by the user equipment to monitor a control channel of the first target base station for a resource grant for the user equipment, and
directing the user equipment to connect to the first target base station;
or
a group reselection command
comprising the received group identifier,
comprising reselection parameters usable by the user equipment to reselect to any of one or more second target base stations of the plurality of target base stations,
comprising priorities or rankings of each of the second target base stations, and
directing the user equipment to reselect one of the second target base stations;
determining, based on the at least one group identifier matching the received group identifier in the group handover command or group reselection command, that the group handover command corresponds to the user equipment; and
if the group handover command is received,
initiating a wireless connection with the first target base station using the handover parameters for the first target base station, or
if the group reselection command is received,
selecting one of the second target base stations based on the priority or ranking of the selected second target base station; and
attempting to camp on the selected second target base station.

11. The method as recited in claim 10, further comprising:
transmitting, by the user equipment and to the source base station, location and movement information of the user equipment or information usable by the source base station to calculate the location and movement information of the user equipment.

12. The method as recited in claim 10, further comprising, if the group reselection command is received:
failing to camp on the selected second target base station;
identifying another second target base station from the second target base stations based on the priority or ranking of the other second target base station; and
attempting to camp on the other second target base station.

13. The method as recited in claim 10, wherein receiving the handover parameters comprises:
receiving a timing advance for use by the user equipment in communicating with the first target base station.

14. A base station apparatus comprising:
a wireless transceiver;
a processor; and
computer-readable storage media comprising instructions to implement a handover/cell reselection manager that responsive to execution by the processor, directs the base station apparatus to:
associate a group of user equipment with at least one group identifier;
transmit the group identifier to the group of user equipment;
determine to initiate a transfer of the group of user equipment from a source base station to one or more target base stations;
for user equipments of the group of user equipment that are in an engaged mode:
negotiate, with a first target base station, handover parameters for the user equipments of the group of user equipment that are in the engaged mode, the handover parameters usable by the user equipments of the group of user equipment that are in the engaged mode to receive resource grants from the first target base station; and
transmit, to the user equipments of the group of user equipment that are in the engaged mode, a group handover command comprising the group identifier and the handover parameters for the first target base station, the group handover command directing the user equipments to connect with the first target base station using the handover parameters; and
for user equipments of the group of user equipment that are in a disengaged mode:
identify one or more second target base stations for use in cell reselection by the user equipments of the group of user equipment that are in the disengaged mode;
transmit, to the one or more second target base stations, contextual information about the user equipments of the group of user equipment that are in the disengaged mode; and
transmit, to the user equipments of the group of user equipment that are in the disengaged mode, a group reselection command comprising the group identifier, the group reselection command directing the user equipments of the group of user equipment that are in the disengaged mode to reselect one of the second target base stations.

15. (canceled)

16. The base station apparatus of claim 14, the instructions further executable to direct the base station apparatus to:
determine at least one timing advance for the user equipments of the group of user equipment that are in the engaged mode for the first target base station,
wherein the handover parameters comprise the timing advance.

17. The base station apparatus of claim 16, the instructions further executable to direct the base station apparatus to:
determine location and movement information for the user equipments of the group of user equipment that are in the engaged mode and a location of the first target base station; and
calculate the timing advance based on the location and movement information.

18. The base station apparatus of claim 17, wherein:
the at least one timing advance comprises a plurality of timing advances; and
each of the plurality of timing advances is applicable to a sub-group of the user equipments of the group of user equipment that are in the engaged mode.

19. A user equipment apparatus comprising:
a wireless transceiver;
a processor; and
computer-readable storage media comprising instructions to implement a handover/cell reselection handler that, responsive to execution by the processor, directs the user equipment apparatus to:
receive, from a source base station, at least one group identifier indicating that the user equipment is part of an associated group of user equipments;
receive, from the source base station at least one of:
a group handover command
comprising a received group identifier,
comprising handover parameters for a first target base station of a plurality of target base stations, the handover parameters usable by the user equipment to monitor a control channel of the first target base station for a resource grant for the user equipment, and
direct the user equipment to connect to the first target base station;
or
a group reselection command
comprising the received group identifier,
comprising reselection parameters usable by the user equipment to reselect to any of one or more second target base stations of the plurality of target base stations,
comprising priorities or rankings of each of the second target base stations, and
direct the user equipment to reselect one of the second target base stations;
determine, based on the at least one group identifier matching the received group identifier in the group handover command or group reselection command, that the group handover command corresponds to the user equipment; and
if the group handover command is received,
initiate a wireless connection with the first target base station using the handover parameters for the first target base station, or if the group reselection command is received,
select one of the second target base stations based on the priority or ranking of the selected second target base station; and
attempt to camp on the selected second target base station.

20. A user equipment apparatus of claim 19, the instructions further executable to direct the user equipment apparatus to:
transmit, to the source base station, location and movement information of the user equipment or information usable by the source base station to calculate the location and movement information of the user equipment.

21. A user equipment apparatus of claim 19, the instructions further executable to direct the user equipment apparatus to:
if the group reselection command is received:
fail to camp on the selected second target base station;
identify another second target base station from the second target base stations based on the priority or ranking of the other second target base station; and
attempt to camp on the other second target base station.
